(19) United States
(12) Patent Application Publication
(10) Pub. No.: US 2016/0003337 A1
(43) Pub. Date: Jan. 7, 2016

(54) DRIVE DEVICE FOR A VEHICLE

(71) Applicant: Schaeffler Technologies AG & Co. KG, Herzogenaurach (DE)

(72) Inventor: Tomas SMETANA, Herzogenaurach (DE)

(21) Appl. No.: 14/767,227

(22) PCT Filed: Jan. 20, 2014
(86) PCT No.: PCT/DE2014/200013

§ 371 Date: Aug. 11, 2015

(30) Foreign Application Priority Data
Feb. 14, 2013 (DE) 10 2013 202 381.2

(51) Int. Cl. F16H 48/05; B60K 6/365; B60K 6/48; F16H 48/06

(52) U.S. Cl. CPC F16H 48/05; F16H 48/06; B60K 6/365; B60K 6/48; Y10S 903/91

(57) ABSTRACT

A flexible drive concept for a vehicle is provided. As a result, the claimed drive device includes a shifting device which can shift a transmission gear and an intermediate gear into different shifting states such that a second motor can be selectively used in two gears as a drive motor or alternatively as a torque vectoring motor.

The present invention relates to a drive device for a vehicle.

Drives for vehicles including two engines are frequently used as hybrid drives, optionally one of the engines or both engines of the drive being used together to drive the vehicle as a function of the operating state of the drive.

### BACKGROUND

The publication DE 10 2006 031 089 A1, which is arguably the most proximate prior art, provides a drive device for a motor vehicle. The drive device is characterized in that it includes an internal combustion engine and an electric motor, in a first operating mode, the drive device operating as a hybrid drive in the case of which an identical power flow takes place on both wheels of the motor vehicle via the main engine, and in another operating mode, a power and torque distribution on the wheels being alternatingly variable via an additional main engine as a function of the predefined parameters.

### SUMMARY OF THE INVENTION

It is an object of the present invention to provide a more flexible drive concept.

The present invention provides a drive device is provided which is suitable and/or designed for a vehicle. The vehicle is, in particular, implemented as a passenger car, a truck, a bus or the like. In particular, the drive device is used to generate and output a drive torque for an axle of the vehicle.

For this purpose, the drive device includes a first and a second output shaft, each of the output shafts being assigned and/or assignable to a wheel of the vehicle. The output shafts are used to transfer the drive torque from the drive device via the output shafts to the wheels.

The drive device includes a first interface for coupling a first engine. The first engine may, for example, be coupled to the first interface via a shaft, in particular via a pinion shaft.

Furthermore, the drive device includes a differential device which is designed for distributing the drive torque from the first interface to the two output shafts. In particular, the drive torque of the first engine is distributed 50:50 to the output shafts without further influences and/or is designed as a transverse differential. The differential device includes an input and two outputs. The input of the differential device is, in particular, drivably coupled to the first interface. In particular, the input of the differential device forms the first interface. The first interface is, for example, implemented as a ring gear which meshes with the pinion shaft. The two outputs of the differential device are, in particular, drivably coupled or rotatably fixedly connected to the first and the second output shafts. In the most general specific embodiment of the present invention, the differential device may be designed as a bevel gear wheel differential device, for example. Preferred specific embodiments of the present invention will be explained in the following.

Furthermore, the drive device includes a second interface for coupling a second engine. In particular, the first engine differs from the second engine with respect to the engine type.

The drive device includes a transmission which is designed for transmitting the drive torque of the second engine. The transmission is preferably designed in such a way that it converts a high rotational speed of the second interface to a lower rotational speed. The transmission includes an input and two outputs. The input of the transmission is coupled to the second interface or forms same. The two outputs are, in particular, assigned to different transmission stages so that different rotational speeds are present at the two outputs of the transmission in the case of the same input rotational speed at the input of the transmission.

Furthermore, the drive device includes an intermediate gear, the intermediate gear being situated in the torque flow, in particular, between the transmission and the differential device. In particular, the drive torque is guided from the second interface to the differential device via the intermediate gear in at least one shifting state of the shifting device.

In addition, the drive device includes a shifting device, the shifting device being operable electromechanically, electrohydrostatically, hydraulically, or electromagnetically, for example. The shifting device is designed to couple the transmission and the intermediate gear to one another in at least two different shifting states. The shifting device may also be referred to as a coupling device or a coupling system.

It is provided within the scope of the present invention that the intermediate gear includes a first and a second input.

With the aid of this constructive design, different shifting states of the shifting device and thus of the drive device are possible:

First Gear:

In a first shifting state of the shifting device, the first output of the transmission is rotatably fixedly connected to the first input of the intermediate gear. In particular, the first output of the transmission is that output which has in comparison to the second output of the transmission a lower rotational speed, while having the same input rotational speed. The intermediate gear is designed in such a way that the drive torque is distributed to the two output shafts from the second interface via the intermediate gear and via the differential device. In this first shifting state, the drive device may thus optionally be powered exclusively by the second engine or in a hybrid state together by the first and the second engines.

Second Gear:

In a second shifting state of the shifting device, the second output of the transmission is rotatably fixedly connected to the first input of the intermediate gear. In this shifting state, the drive torque is also distributed to the output shafts from the second interface, i.e., from the second engine, via the differential device in order to optionally allow for an exclusive drive by the second engine or a hybrid drive with the aid of the two engines.

TV Mode (Torque Vectoring Mode):

In the third shifting state of the shifting device, the first or the second output, preferably the first output of the transmission, is rotatably fixedly connected to the second input of the intermediate gear so that the drive torque of the second interface is usable for a drive torque distribution. In this TV mode, the power and/or the torque distribution to the output shafts may be influenced via the second engine.

The advantage of the present invention is thus to be seen in that the drive device may make available two hybrid gears and one torque distribution gear despite the simple design. At the same time, the constructive design is enlarged only to a minor degree as compared to the prior art. It is to be stressed, in particular, that the second engine is used for the drive as well as for the torque distribution.

In one preferred refinement of the present invention, the shifting device is designed to assume a TV intermediate shifting state which is between the second and the third shifting state. In this intermediate shifting state, the first and the second outputs of the transmission are freewheeling. In particular, the intermediate shifting state is assumed at the transition from the second to the third shifting state. The advantage of the TV intermediate shifting state is that at that point in time when the first and the second outputs of the transmission are freewheeling, the rotational speed of the second interface or of the second engine may be adapted to the changed function. While in the first and in the second gears a concurrent movement of the second interface or of the second engine at a rotational speed which matches the rotational speed of the output shafts is necessary, in the third shifting state, a standstill of the second interface or of the second engine is necessary at least when the vehicle is driving straight ahead. In this way, the TV intermediate shifting state has the advantage that the second interface or the second engine may be decelerated during the change from the second to the third shifting state and/or accelerated during the transition from the third shifting state to the second shifting state and may be synchronized with the required rotational speed.

In addition, the shifting device is optionally designed to assume a drive intermediate shifting state between the first shifting state and the second shifting state, the first and the second outputs of the transmission also being freewheeling in the drive intermediate shifting state so that the rotational speed of the second interface or of the second engine may be adapted to the changing transmission.

In one preferred constructive embodiment of the present invention, the intermediate gear includes a drive gear section and a distribution gear section.

In one possible constructive embodiment of the present invention, the drive gear section includes a first input of the intermediate gear and a first output of the intermediate gear to the differential device. The distribution gear section includes the second input of the intermediate gear, a second output of the intermediate gear to one of the output shafts, and a coupling output, the coupling output being, in particular, rotatably fixedly coupled to the first input of the intermediate gear. In this embodiment, the functions of the intermediate gear may be implemented via the drive gear section in the first and in the second shifting states and the function of the intermediate gear may be implemented via the distribution gear section in the third shifting state.

With regard to the construction, it is preferred that the drive gear section is designed as a drive planetary gear set, in particular as a spur planetary gear set including gear wheels which are circumferentially teethed at the front sides. The drive planetary gear set includes a sun gear, a planetary carrier, an annulus gear as well as a set of planet wheels which are rotatably situated on the planetary carrier and which mesh with the sun gear and the annulus gear. The first input of the intermediate gear is, in particular, rotatably fixedly coupled to the sun gear. A or the first output of the intermediate gear is, in particular, rotatably fixedly coupled to the planetary carrier. The annulus gear is, in particular, rotatably fixedly coupled to a stationary surrounding structure, e.g., a housing or the like. Due to this design, the drive gear section may be implemented to be very narrow and in addition lightweight, in particular in the axial extension.

It is also preferred that the distribution gear section is designed as a distribution planetary gear set. The distribution planetary gear set includes a sun gear, a planetary carrier, an annulus gear as well as a set of planet wheels which are rotatably mounted on the planetary carrier and which mesh with the annulus gear and the sun gear. The second input of the intermediate gear is, in particular, rotatably fixedly coupled to the annulus gear. A or the second output of the intermediate gear to one of the output shafts is, in particular, rotatably fixedly coupled to the planetary carrier. A or the coupling output of the distribution planetary gear set which is, in particular, rotatably fixedly coupled to the first input of the intermediate gear is, in particular, rotatably fixedly coupled to the sun gear.

In particular, in the case that the drive gear section as well as the distribution gear section is designed as a planetary gear set, the intermediate gear may be constructed to be very narrow and in addition lightweight in the axial extension.

In one preferred refinement of the present invention, the differential device is designed as a differential planetary gear set. In one preferred embodiment, the differential planetary gear set includes an annulus gear, a planetary carrier and a sun gear, two sets of planet wheels being situated on the planetary carrier which mesh in pairs with one another and a set of planet wheels meshing with the annulus gear and the other set of planet wheels meshing with the sun gear. The annulus gear is rotatably fixedly connected to the first interface and in addition to the first output of the intermediate gear. The sun gear is, in particular, rotatably fixedly coupled to one of the output shafts; the planetary carrier is, in particular, rotatably fixedly coupled to the other output shaft.

Particularly preferably, the first and the second outputs of the transmission as well as the first and the second inputs of the intermediate gear are designed as output or input gears which are circumferential and/or toothed on the front side, these wheels having the same diameter, in particular. The shifting device may include a shifting member having coupling areas which are spaced apart from one another in the axial direction; the coupling areas are situated in such a way that in the case of an axial displacement of the shifting member in one direction, the first shifting state, the first drive intermediate shifting state, the second shifting state, the TV intermediate shifting state, and the third shifting state are consecutively selected or set.

In one possible specific embodiment of the present invention, the transmission is designed as a one-stage transmission planetary gear set. The one-stage transmission gear set includes a sun gear, a planetary carrier as well as an annulus gear. The annulus gear is, in particular, rotatably fixedly connected to a surrounding structure and is thus stationary. The planetary carrier is, in particular, rotatably fixedly coupled to the first output; the sun gear is rotatably fixedly coupled to the second output. At the same time, the sun gear forms the input to the one-stage intermediate gear or is, in particular, rotatably fixedly coupled thereto.

Alternatively, the transmission may be designed as a two-stage transmission planetary gear set which has a first and a second planet set. Each of the planet sets includes a sun gear, a planetary carrier as well as a set of planet wheels. An annulus gear of the first and the second planet sets is designed as a joint annulus gear. The input of the transmission planetary gear set is coupled, in particular rotatably fixedly connected, to the sun gear of the first planet set. The first output is rotatably fixedly connected to the planetary carrier of the second planet set; the second output is coupled, in particular rotatably fixedly connected, to the sun gear of the second planet set. The joint annulus gear is situated stationary in a surrounding structure, in particular a housing. The planetary carrier of the first planet set is rotatably fixedly coupled to the sun gear of the second planet set. In this embodiment, the transmission ratio may be implemented to be higher.

In one particularly preferred embodiment of the present invention, the drive planetary gear set, the distribution planetary gear set, and the transmission planetary gear set, in particular the one- or two-stage transmission planetary gear set, are situated coaxially to a joint main axis of rotation. In addition, the differential planetary gear set may optionally also be situated coaxially to this joint main axis of rotation. Due to this construction, a great compactness of the drive device may be achieved on the one hand, and the design of the shifting unit is considerably simplified on the other hand.

In one possible refinement of the present invention, the drive device includes the first and the second engines, the first engine being designed as an internal combustion engine and the second engine being designed as an electric motor. This embodiment has the advantage that the electric motor may be rotated in any arbitrary direction for the purpose of generating a drive torque for the second interface so that the torque distribution may be easily implemented.

A rotor axis of the electric motor is particularly preferably situated coaxially to the joint main axis of rotation. Alternatively, the rotor axis of the electric motor is offset in parallel to the joint main axis of rotation.

Another object relates to a vehicle including the drive device, the two output shafts being optionally assigned to the front axle or to the rear axle of the vehicle.

### BRIEF DESCRIPTION OF THE DRAWINGS

Other features, advantages, and effects of the present invention are derived from the following description of preferred exemplary embodiments of the present invention as well as from the accompanying figures.

FIG. 1 shows a schematic representation of a drive device as a first exemplary embodiment of the present invention;

FIGS. 2 through 6 show the drive device from FIG. 1 in different shifting states;

FIG. 7 shows a first variant of the drive device from the preceding figures; and

FIG. 8 shows a second variant of the drive device from the preceding figures.

### DETAILED DESCRIPTION

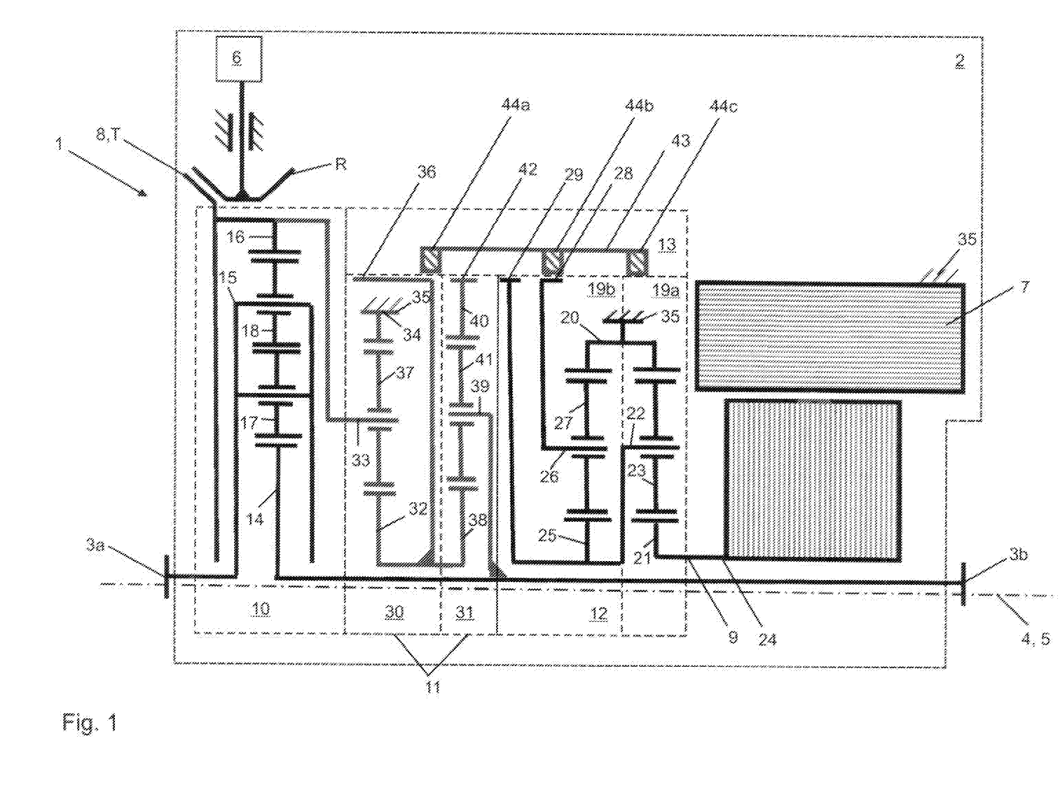

FIG. 1 illustrates in a schematic representation a drive device 1 for a vehicle 2 as one exemplary embodiment of the present invention. Drive device 1 includes two output shafts 3a, b which are drivably coupled to the wheels of vehicle 2. It is possible in this case that output shafts 3a, b are rotatably fixedly connected to the wheels or via a further gear. Output shafts 3a, b define a joint output axle 4. In addition, the output shafts define a main axis of rotation 5.

Vehicle 2 includes a first engine 6, which is designed as an internal combustion engine, as well as a second engine 7, which is designed as an electric motor, for the purpose of generating a drive torque for output shafts 3a, b. First engine 6 is connected to drive device 1 via a first interface 8; second engine 7 is coupled to drive device 1 via a second interface 9. The drive torque of engines 6, 7 is guided into drive device 1 via interfaces 8, 9.

From a schematic point of view, drive device 1 includes a differential planetary gear set 10 as a differential device, an intermediate gear 11, a transmission planetary gear set 12 as a transmission as well as a shifting device 13 which is able to couple transmission 12 and intermediate gear 11 to one another in different shifting states.

Differential Planetary Gear Set 10:

Differential planetary gear set 10 includes a sun gear 14, a planetary carrier 15, an annulus gear 16 as well as two sets of planet wheels 17, 18. The two sets of planet wheels 17, 18 are rotatably situated on planetary carrier 15. The two sets of planet wheels 17, 18 mesh in pairs with one another so that a planet wheel of set 17 meshes with a planet wheel of set 18 in each case. In addition, the planet wheel of set 17 meshes with sun gear 14 and the planet wheel of set 18 meshes with annulus gear 16.

Planetary carrier 15 forms a first output of differential planetary gear set 10 and is rotatably fixedly connected to output shaft 3a. Sun gear 14 forms a second output of differential planetary gear set 10 and is rotatably fixedly connected to output shaft 3b. Annulus gear 16 includes a ring gear T which meshes with a pinion shaft R, ring gear T forming first interface 8. Sun gear 14, planetary carrier 15, and annulus gear 16 are situated coaxially to main axis of rotation 5.

Differential planetary gear set 10 has the function of evenly distributing the drive torque of first engine 6 to output shafts 3a, b.

Transmission Planetary Gear Set 12:

Transmission planetary gear set 12 includes a first planet set 19a and a second planet set 19b. Both planet sets 19a, b have a joint annulus gear 20. First planet set 19a includes a sun gear 21, a planetary carrier 22 as well as a set of planet gears 23. Sun gear 21 forms second interface 9 and is rotatably fixedly coupled to a rotor shaft 24 of second engine 7 in this exemplary embodiment. The set of planet gears 23 meshes, on the one hand, with joint annulus gear 20 and on the other hand, with sun gear 21. Sun gear 21 thus forms an input to transmission planetary gear set 12.

Second planet set 19b includes a sun gear 25, a planetary carrier 26, and a set of planet gears 27, planet gears 27 meshing with sun gear 25 and joint annulus gear 20. Sun gear 25 of second planet set 19b is rotatably fixedly connected to planetary carrier 22 of first planet set 19a so that planetary carrier 22 forms an intermediate output.

Planetary carrier 26 forms a first output of transmission planetary gear set 12. Sun gear 25 forms a second output of transmission planetary gear set 12.

Planetary carrier 26 is rotatably fixedly coupled to a first output gear 28; sun gear 25 is rotatably fixedly coupled to a second output gear 29. First and second output gears 28, 29 are situated coaxially to main axis of rotation 5.

Intermediate Gear 11:

Intermediate gear 11 includes a drive planetary gear set 30 as the drive gear section and a distribution planetary gear set 31 as the distribution gear section. Drive planetary gear set 30 includes a sun gear 32, a planetary carrier 33, and an annulus gear 34, annulus gear 34 being situated in a surrounding structure U just as is joint annulus gear 20. Sun gear 32 is rotatably fixedly coupled to a first input gear 36. A set of planet wheels 37 meshes with sun gear 32 and annulus gear 34. Sun gear 32 forms the input to drive planetary gear set 30. Planetary carrier 33 forms the first output of drive planetary gear set 30 or of intermediate gear 11 and is rotatably fixedly connected to annulus gear 16 of differential planetary gear set 10.

Distribution planetary gear set 31 includes a sun gear 38, a planetary carrier 39, an annulus gear 40 as well as a set of planet gears 41, set of planet gears 41 meshing with sun gear 38 and annulus gear 40. Annulus gear 40 simultaneously forms a second input gear 42. Planetary carrier 39 is rotatably fixedly coupled to output shaft 3b. Sun gear 38 is rotatably fixedly coupled to first input gear 36 and at the same time to sun gear 32 of drive planetary gear set 30.

First input gear 36, second input gear 41-42 as well as planetary carriers 33, 39 are situated coaxially to main axis of rotation 5.

Shifting Device 13:

Shifting device 13 is used to set the different shifting states so that intermediate gear 11 and transmission planetary gear set 12 may assume different operating states. For this purpose, output gears 28, 29 are differently rotatably fixedly connected to input gears 36, 42. The wheels are situated in series in the sequence of first output gear 28, second output gear 29, second input gear 42, and first input gear 36. Gears 28, 29, 36, 42 each have the same outer diameter.

Shifting device 13 includes a shifting member 43 which is situated displaceably in the axial direction and which includes three coupling areas 44a, b, c, free areas being situated between coupling areas 44a, b, c. Coupling areas 44a, b, c are designed to engage in a rotatably fixed coupling with gears 28, 29, 36, 42 in the case of an overlap in the axial direction. If one of gears 28, 29, 36, 42 is situated in one of the free areas, shifting member 43 and the wheel in the free area are not coupled in the circumferential direction. Shifting member 43 may, for example, be designed in the form of a sleeve having internal toothing or as a shift collar. The activation of shifting member 43 may be carried out electromechanically, electrohydrostatically, hydraulically, or electromagnetically.

The different shifting states of shifting device 13 are described in conjunction with the following figures:

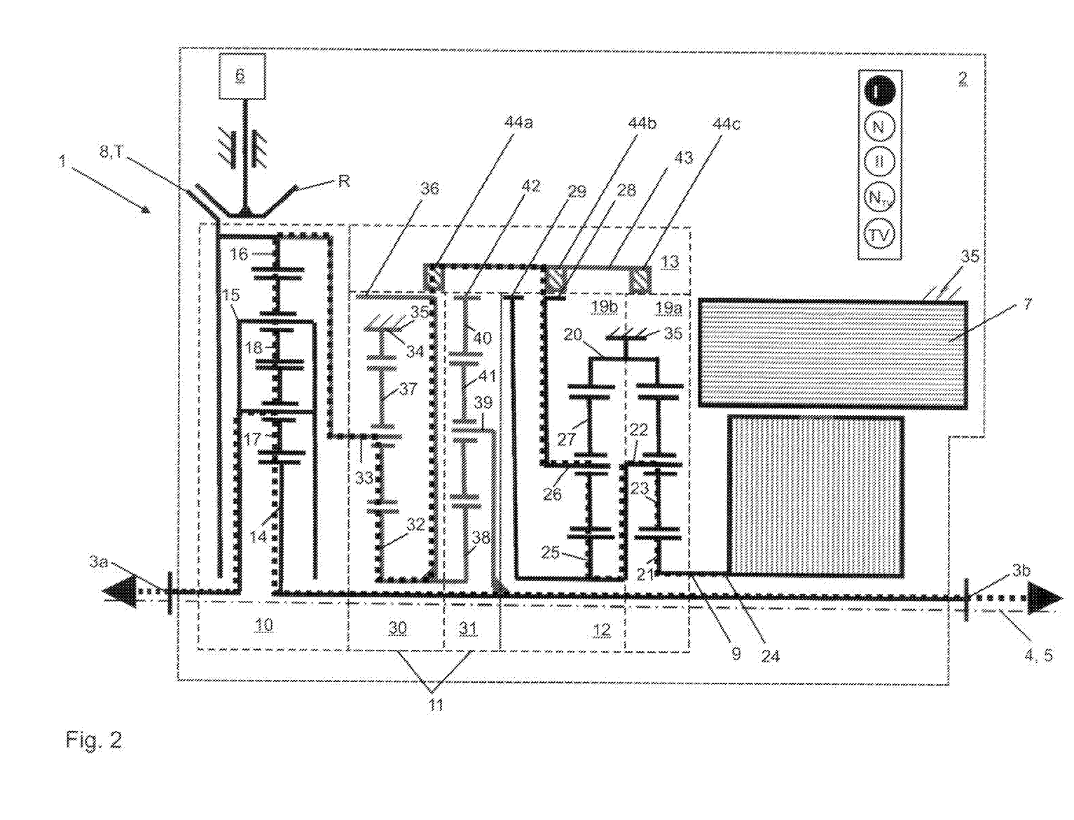

FIG. 2 shows first shifting state I, first output gear 28 being rotatably fixedly coupled to first input gear 36 via shifting member 43. For this purpose, coupling area 44a engages in an operative connection with first input gear 36 and coupling area 44b engages in an operative connection with first output gear 28. In this shifting state, the drive torque for output shafts 3a, b may be optionally generated via second engine 7 or as a hybrid drive jointly via first engine 6 and second engine 7. The torque flow from second engine 7 is illustrated in FIG. 2 as a dashed line and runs from rotor shaft 24 via the two planet sets 19a, b and output gear 28, shifting member 43, first input gear 36, and drive planetary gear set 30 to differential planetary gear set 10. The drive torque flow of first engine 6 is not illustrated, but it runs from first interface 8 via differential planetary gear set 10 to output shafts 3a, b.

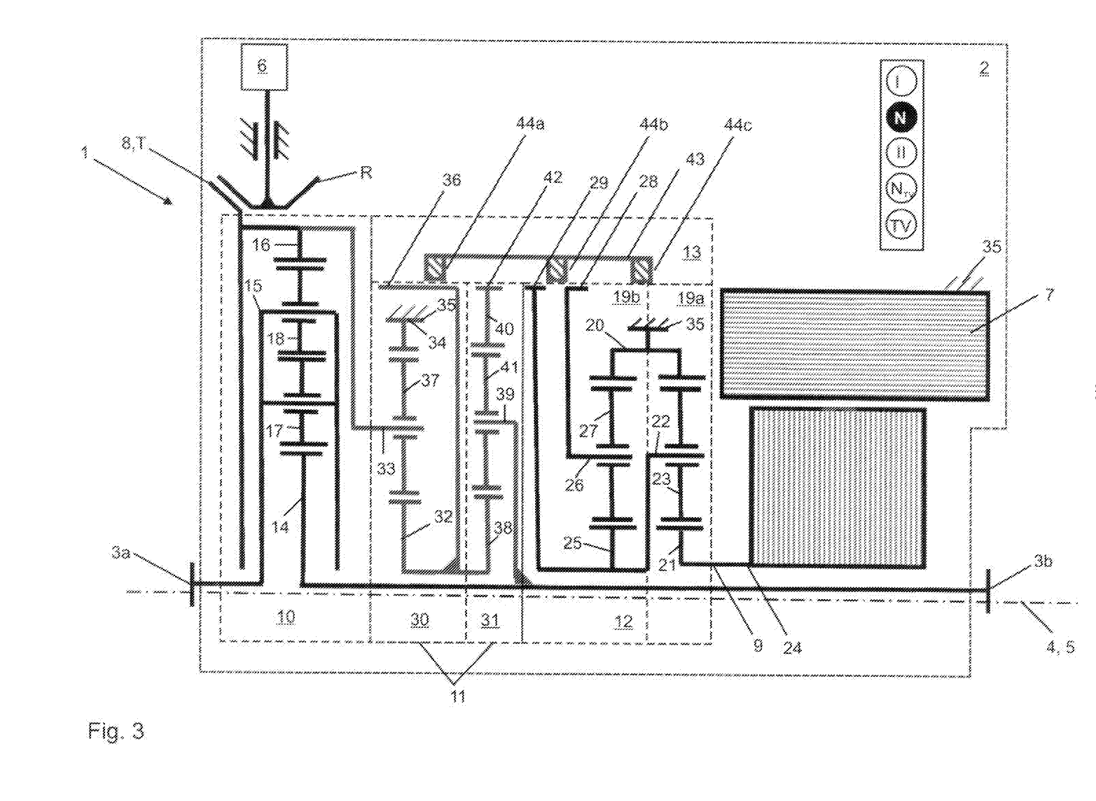

As illustrated in FIG. 3, a drive intermediate shifting state N (neutral) may be achieved with the aid of an axial offset of shifting member 43, first coupling area 44a still being in operative connection with first input gear 36, second coupling area 44b, however, being situated between first and second output gears 28, 29 so that these two are freewheeling. In this drive intermediate shifting state N, second engine 7 is in a neutral position so that it may set—decoupled from output shafts 3a, b—its rotational speed in any arbitrary way. If during operation of vehicle 2 it is shifted from first shifting state Ito second shifting state II, second engine 7 must be adapted with respect to its rotational speed during the transition. This may take place in drive intermediate shifting state N.

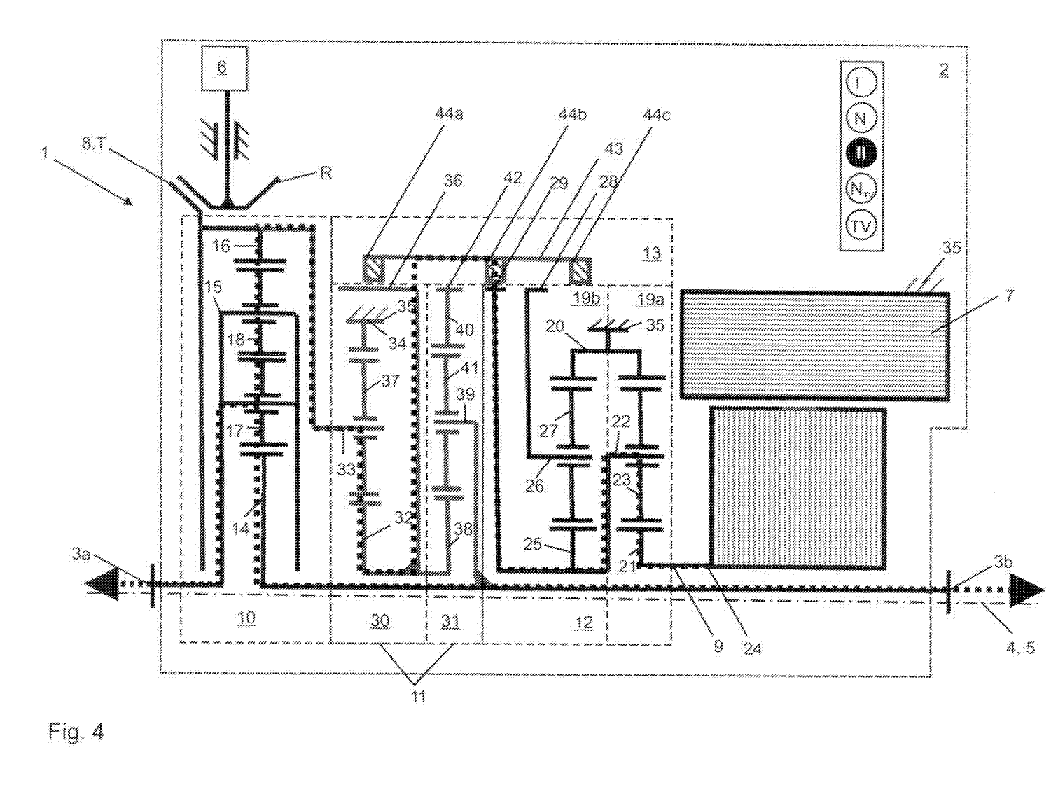

In FIG. 4, second shifting state II is illustrated, first coupling area 44a being in operative connection with, i.e., being rotatably fixedly coupled to, first input gear 36, second coupling area 44b now, however, being in operative connection with second output gear 29. The plotted torque flow from second engine 7 to output shafts 3a, b now runs via second output gear 29. The speed-transformation is reduced in second shifting state II so that, for the same input rotational speed at second interface 9, a higher output rotational speed is applied at the used output of transmission planetary gear set 12 in comparison to first shifting state I. The torque flow is again illustrated using a dashed line, the difference from FIG. 2 being that the transition from transmission planetary gear set 12 to intermediate gear 11 takes place via second output gear 29.

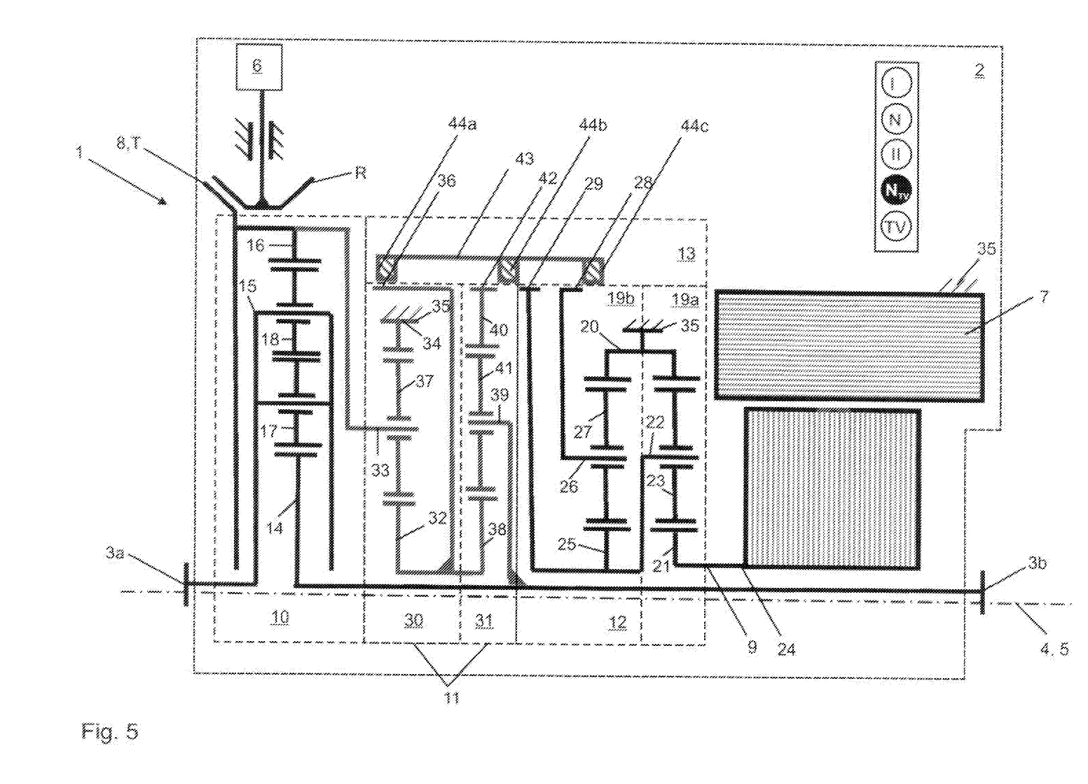

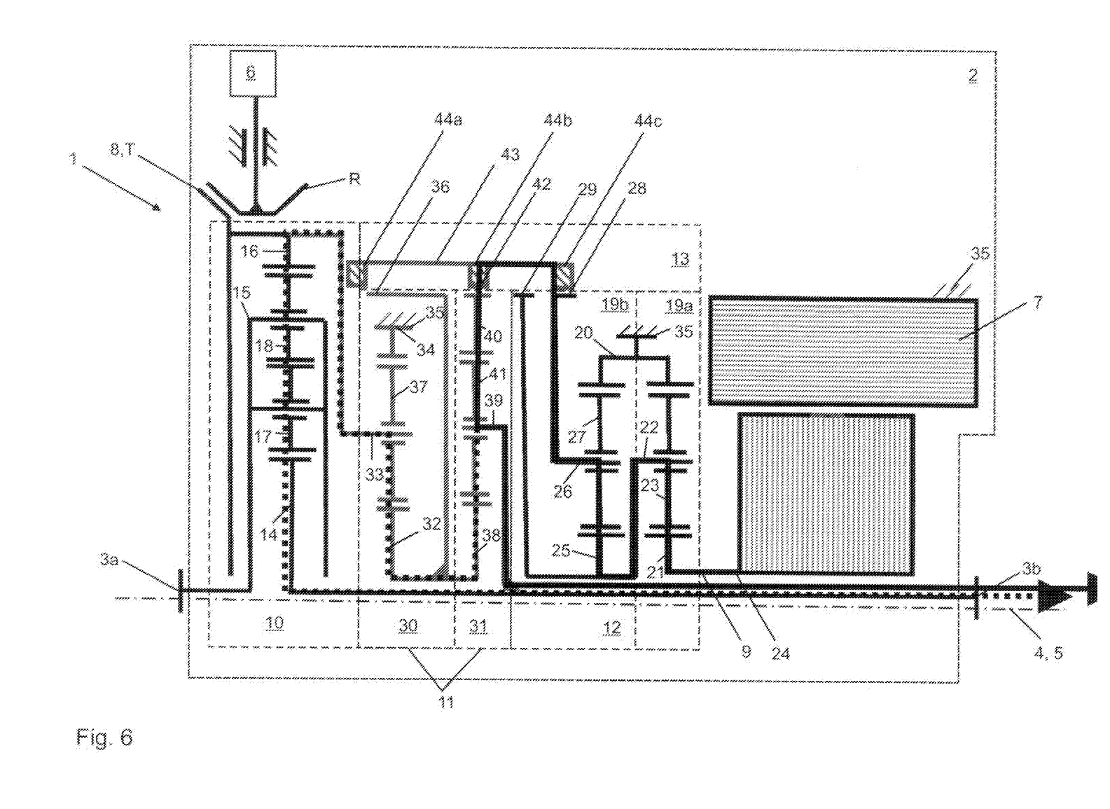

In FIG. 5, a TV intermediate shifting state NTV is shown, first coupling area 44a still being engaged with first input gear 36, and second coupling area 44b and third coupling area 44c being free. In this second TV intermediate shifting state, second input gear 42 and first and second output gears 28, 29 may rotate freely. As far as the shifting sequence is concerned, it is shifted from a hybrid transmission to a transmission having an active torque distribution. During the transition from the function of the hybrid transmission to the function of the torque distribution, first or second output gears 28, 29 and thus second engine 7 must be decelerated. In order to achieve this, the TV intermediate shifting state is used.

By further offsetting shifting member 43 in the axial direction, first coupling area 44a is decoupled from first input gear 36. In contrast, second coupling area 44b is in operative connection with second input gear 42 and third coupling area 44c is in operative connection with first output gear 28. As is apparent from the illustrated torque flow, it is now possible to bring about an active torque distribution through the activation of second engine 7 by actively rotating second input gear 42 clockwise or counterclockwise.

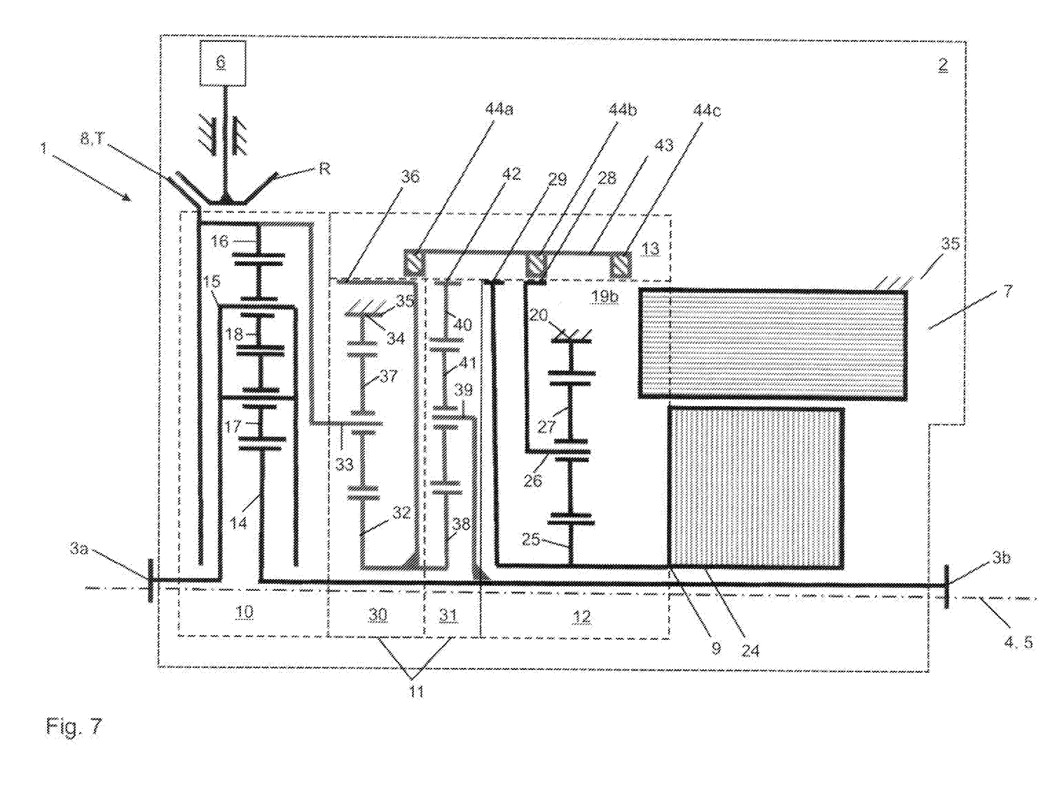

FIG. 7 shows a first variant of drive device 1 from the preceding figures, transmission planetary gear set 12 being designed as a simply reducing planet gear set which now only includes second planet set 19b. Annulus gear 20 is assigned exclusively to planet set 19b. Rotor shaft 24 or second interface 9 is rotatably fixedly connected to sun gear 25 which forms the input to transmission 12. The functionality of shifting device 13 corresponds to the functionality described in the preceding figures.

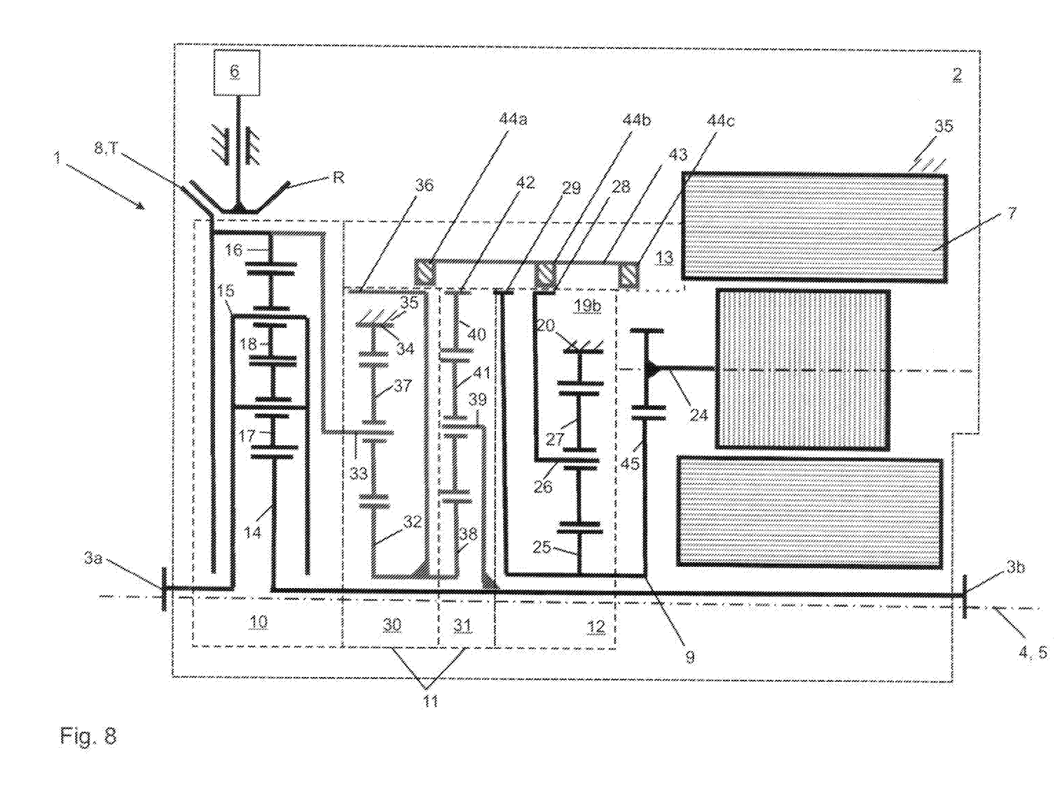

FIG. 8 illustrates a second variant of drive device 1 from the preceding figures, second engine 7 being designed as an electric motor and being offset in parallel to main axis of rotation 5 with its rotor shaft 24. The drive torque from second engine 7 is supplied via an additional gear 45 which, on the one hand, compensates for a parallel offset between the rotor shaft and main axis of rotation 5 and, on the other hand, forms a first transmission stage.

It must be stressed that shifting states 1, first intermediate shifting state NTV, and second intermediate shifting state TV may be assumed through a serial displacement of the shifting member in a single axial direction. In order to achieve this, it is particularly advantageous that first input gear 36, second input gear 42, first output gear 28, and second output gear 29 have the same outer diameter. Shifting member 43 may, for example, be designed in the form of a sleeve having internal toothing with/without an undercut analogously to a sliding collar. The activation of shifting member 43 is preferably electromechanical, furthermore electrohydrostatic, hydraulic, or electromagnetic.

With the aid of shown drive device 1 it is achieved that the shifting takes place in a defined sequence so that at any point in time or shifting point only one function (drive, neutral, TV) is implemented in order to avoid a maloperation (e.g., simultaneous activation of TV and drive). The sequence may reach the different shifting states without reversal of the direction of shifting member 43, thus resulting in a rapid as well as reliable shifting.

### LIST OF REFERENCE NUMERALS

1 drive device
2 vehicle
3a, b output shafts
4 output axle
5 main axis of rotation
6 first engine
7 second engine
8 first interface
9 second interface
10 differential planetary gear set
11 intermediate gear
12 transmission planetary gear set
13 shifting device
14 sun gear
15 planetary carrier
16 annulus gear
17 planet wheels
18 planet wheels
T ring gear
R pinion shaft
19a, b planet sets
20 annulus gear
21 sun gear
22 planetary carrier
23 planet gears
24 rotor shaft
25 sun gear
26 planetary carrier
27 planet gears
28 first output gear
29 second output gear
30 drive planetary gear set
31 distribution planetary gear set
32 sun gear
33 planetary carrier
34 annulus gear
35 surrounding structure
36 first input gear
37 planet wheels
38 sun gear
39 planetary carrier
40 annulus gear
41 planet gears
42 second input gear
43 shifting member
44a, b, c coupling areas
45 additional gear

1-15. (canceled)

16. A drive device for a vehicle, comprising:
a first and a second output shaft;
a first interface for coupling a first engine;
a differential device for distributing the drive torque from the first interface to the first and second output shafts, the differential device including an input and two outputs, the input of the differential device being coupled to the first interface, the two outputs of the differential device being coupled to the first and the second output shafts;
a second interface for coupling a second engine;
a transmission for transmitting the drive torque of the second engine or of the second interface, the transmission including a transmission input and two transmission outputs and the transmission input of the transmission being coupled to the second interface;
an intermediate gear, the intermediate gear being situated between the transmission and the differential device; and
a shifter, the shifter being designed to couple the transmission and the intermediate gear to one another in at least two different shifting states; the intermediate gear including a first and a second input, in a first shifting state of the shifter the first transmission output of the transmission being rotatably fixedly connected to the first input of the intermediate gear so that drive torque is distributed to the first and second output shafts from the second interface via the differential device;
in a second shifting state of the shifter, the second transmission output of the transmission being rotatably fixedly connected to the first input of the intermediate gear so that the drive torque is distributed to the first and second output shafts from the second interface via the differential device; and
in a third shifting state of the shifter, the first or the second transmission output of the transmission is rotatably fixedly connected to the second input of the intermediate gear so that the drive torque of the second interface is usable for a drive torque distribution.

17. The drive device as recited in claim 16 wherein in a TV intermediate shifting state between the second and the third shifting states, the first and the second transmission outputs of the transmission are freewheeling in order to allow for a change in the rotational speed at the second interface for the transition between the second and the third shifting states.

18. The drive device as recited in claim 16 wherein the intermediate gear includes a drive gear section and a distribution gear section.

19. The drive device as recited in claim 18 wherein the drive gear section includes the first input of the intermediate gear and a first output of the intermediate gear to the differential device and the distribution gear section includes the second input of the intermediate gear, a second output of the intermediate gear to one of the first and second output shafts, and a coupling output coupled to the first input of the intermediate gear.

20. The drive device as recited in claim 18 wherein the drive gear section is designed as a drive planetary gear set, the first input of the intermediate gear being coupled to a sun gear of the drive planetary gear set and the first output of the intermediate gear being coupled to a planetary carrier of the drive planetary gear set, and a surrounding structure being coupled to an annulus gear of the drive planetary gear set.

21. The drive device as recited in claim 18 wherein the distribution gear section is designed as a distribution planetary gear set, the second input of the intermediate gear being coupled to an annulus gear of the distribution planetary gear set and the second output of the intermediate gear to one of the first and second output shafts being coupled to a planetary carrier of the distribution planetary gear set, and the coupling output of the distribution planetary gear set coupled to the first input of the intermediate gear being coupled to a sun gear of the distribution planetary gear set.

22. The drive device as recited in claim 16 wherein the differential device is designed as a differential planetary gear set, an input of the differential planetary gear set being coupled to an annulus gear of the differential planetary gear set, the first output of the differential planetary gear set being coupled to a planetary carrier of the differential planetary gear set, and the second output of the differential planetary gear set being coupled to a sun gear of the differential planetary gear set.

23. The drive device as recited in claim 16 wherein the shifter includes a shifting member having three coupling areas, the shifting member being displaceable in the axial direction.

24. The drive device as recited in claim 16 wherein the transmission is designed as a one-stage transmission planetary gear set, the input being coupled to a sun gear of the transmission planetary gear set, the first output being coupled to a planetary carrier of the transmission planetary gear set, the second output being coupled to the sun gear of the transmission planetary gear set, and a surrounding structure being coupled to an annulus gear of the transmission planetary gear set.

25. The drive device as recited in claim 16 wherein the transmission is designed as a two-stage transmission planetary gear set, the input being coupled to a sun gear of a first planet set of transmission planetary gear set, the first output being coupled to a planetary carrier of a second planet set of the transmission planetary gear set, the second output being coupled to the sun gear of the second planet set of the transmission planetary gear set, and a surrounding structure being coupled to a joint annulus gear of the first and the second planet sets of the transmission planetary gear set, a planetary carrier of the first planet set being rotatably fixedly coupled to the sun gear of the second planet set.

26. The drive device as recited in claim 16 wherein the drive planetary gear set, the distribution planetary gear set, and the transmission planetary gear set are situated coaxially to a joint main axis of rotation.

27. The drive device as recited in claim 16 wherein the drive device includes the first and the second engines, the first engine being an internal combustion engine and the second engine being an electric motor.

28. The drive device as recited in claim 27 wherein a rotor axis of the electric motor is situated coaxially to a joint main axis of rotation.

29. The drive device as recited in claim 27 wherein a rotor axis of the electric motor is offset in parallel to a joint main axis of rotation.

30. A vehicle comprising the drive device as recited in claim 16.
